(19) United States
(12) Patent Application Publication
(10) Pub. No.: US 2007/0061355 A1
(43) Pub. Date: Mar. 15, 2007

(54) Computer- implemented method, system, and program product for managing data for an information technology (IT) migration

(75) Inventors: Julie M. Carey, Rye Brook, NY (US); Carol I. DelGaudio, Williston, VT (US); Brenda L. Fowler, Castle Creek, NY (US); Anne M. Henderson, Essex Junction, VT (US); Scott D. Hicks, Underhill Center, VT (US); William M. Houston, Newburgh, NY (US); James A. Martin JR., Endicott, NY (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/225,608

(22) Filed: Sep. 13, 2005

(51) Int. Cl. G06F 7/00

(52) U.S. Cl. 707/102

(57) ABSTRACT

The present invention provides a computer-implemented method, system, and program product for managing data for an IT migration. Specifically, the present invention provides a centralized/integrated system to receive and manage all data related to an IT migration. In addition, the present invention provides customized electronic views containing subsets of data that can be generated based on roles of users requesting the view. Still yet, the present invention allows data shown in an electronic view of be modified.

### BACKGROUND OF THE INVENTION

1. Field of the Invention

In general, the present invention relates to data management for an Information Technology (IT) migration. Specifically, the present invention provides centralized data management and electronic view generation for the IT migration.

2. Related Art

As Information Technology (IT) continues to advance, many organizations are faced with the task of migrating their existing computer infrastructures, telephone systems and the like to newer technology. For example, an organization might wish to migrate its networking functions from token ring to Ethernet. Similarly, an organization might wish to migrate its telephone service from landline-based service to voice-over-IP service.

An IT migration can not only involve adding components such as hardware or software of a computer infrastructure, but it can also involve the physical relocation of existing devices and/or components. To this extent, there are often various pieces of data that are needed or generated for the IT migration. For example, data in IT migration can include physical location/address information, scheduling information, configuration information status information, etc. In general, there are often many individuals involved with an IT migration. To perform their jobs, the users generally require access to subsets of the data.

Unfortunately, existing approaches fail to provide a single, integrated system that can be used to manage the data for the IT migration. Specifically, existing approaches consisted of a combination of separate tools, such as e-mail, telephone communications, paper work orders, spreadsheets that contain configuration data, printouts of system configurations, paper or electronic worksheets that contain planned configuration specifications, network configuration databases, or project management applications. Passing the information from one step to the next requires exporting and importing, copying and pasting, printing, or writing to take data from one tool to the next. The status of prerequisite tasks is also currently communicated via e-mail, telephone, etc. As such, use of these disjointed systems is time consuming, labor intensive, and prone to errors.

### SUMMARY OF THE INVENTION

In general, the present invention provides a computer-implemented method, system, and program product for managing data for an IT migration. Specifically, the present invention provides a centralized/integrated system to receive and manage all data related to an IT migration. In addition, the present invention provides customized electronic views containing subsets of data that can be generated based on roles of users requesting the view. Still yet, the present invention allows data shown in an electronic view of be modified.

A first aspect of the present invention provides a computer-implemented method for managing data for an Information Technology (IT) migration, comprising: obtaining the data for the IT migration from a database; and generating an electronic view containing a subset of the data based on a role of a user requesting the electronic view.

A second aspect of the present invention provides a system for managing data for an Information Technology (IT) migration, comprising: a system for obtaining the data for the IT migration from a database; a system for generating an electronic view containing a subset of the data based on a role of a user requesting the electronic view; a system for displaying the electronic view to the user; and a system for editing the subset of the data in the electronic view.

A third aspect of the present invention provides a program product stored on a computer useable medium for managing data for an Information Technology (IT) migration, the computer useable medium comprising program code for causing a computer system to perform the following steps: obtaining the data for the IT migration from a database; generating an electronic view containing a subset of the data based on a role of a user requesting the electronic view; displaying the electronic view to the user; and editing the subset of the data in the electronic view.

A fourth aspect of the present invention provides a method for deploying an application for managing data for an Information Technology (IT) migration, comprising: providing a computer infrastructure being operable to: obtain the data for the IT migration from a database; generate an electronic view containing a subset of the data based on a role of a user requesting the electronic view; display the electronic view to the user; and edit the subset of the data in the electronic view.

A fifth aspect of the present invention provides computer software embodied in a propagated signal application for managing data for an Information Technology (IT) migration, the computer software comprising instructions to cause a computer system to perform the following functions: obtain the data for the IT migration from a database; generate an electronic view containing a subset of the data based on a role of a user requesting the electronic view; display the electronic view to the user; and edit the subset of the data in the electronic view.

Therefore, the present invention provides a computer-implemented method, system, and program product for managing data for an IT migration.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing data for an IT migration according to the present invention.

FIG. 2 shows an illustrative electronic view according to the present invention.

FIG. 3 shows another illustrative electronic view according to the present invention.

FIG. 4 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the present invention provides a computer-implemented method, system, and program product for managing data for an IT migration. Specifically, the present invention provides a centralized/integrated system to receive and manage all data related to an IT migration. In addition, the present invention provides customized electronic views containing subsets of data that can be generated based on roles of users requesting the view. Still yet, the present invention allows data shown in an electronic view of be modified.

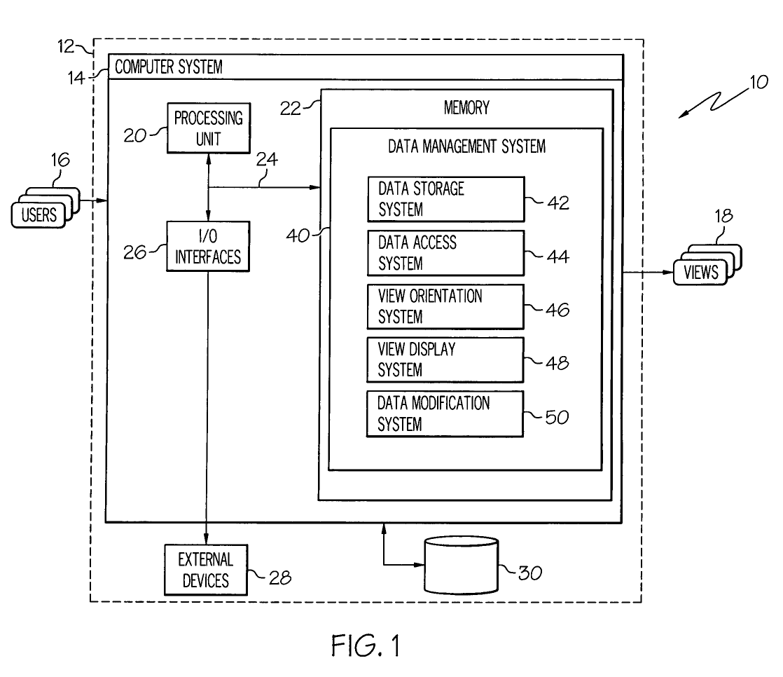

Referring now to FIG. 1, a system 10 for managing data for an IT migration according to the present invention is shown. Specifically, FIG. 1 depicts a system 10 in which data input for an IT migration can be centrally managed. In addition, system 10 allows electronic views 18 containing subsets of the data to be generated and displayed based on a role of a requesting user 16. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to manage data for an IT migration.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as data management system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such as IT migration data, user roles, rules, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is data management system 40, which includes data storage system 42, data access system 44, view generation system 46, view display system 48, and data modification system 50. As will be further described below, data management system 40 provides a single integrated workflow management system to be used for IT migration activities such as network address configurations.

Under the present invention, migration data will be input (e.g., by users 16 or other parties) and stored in a common database such as storage system 30 by data storage system 42. To this extent, data storage system 42 should be understood to provide any interfaces, forms or the like needed to electronically provide the migration data. Moreover, the migration data can include any type of data that might exists pursuant to an IT migration. For example, the migration data could include host information, address information, location information, migration information, type information, schedule information, component information, status information, owner information, driver information, configuration information, etc., for a device undergoing the IT migration. As mentioned above, different pieces of the migration data are typically input by different individuals. Previous approaches for storing and presenting the data involved multiple disparate resources such as spreadsheets and the like. In contrast, the present invention provides a single integrated system for storing and presenting (e.g., managing) all types of migration data.

In any event, assume that the migration data has been input (e.g., by various individuals at various times) and stored in storage system 30. Further assume that a user 16 wishes to view the migration data or a subset thereof. Under the present invention, user can submit a request to view data via data access system 44. Based on the user 16's role or permission within the organization, view generation system 44 will generate an electronic view 18 containing a subset of the migration data (e.g., a subset that the user 16 is allowed to see, or needs to see) that is contained within storage system 30. For example, it could be the case that user 16 requesting to view data is responsible for physically re-locating computer hardware. In such a case, view generation system 46 will retrieve/obtain data applicable to that role (e.g., physical address or location information, schedule information, etc.) from storage system, 30 and generate a customized electronic view 18 containing the same. Data that is extraneous to user 16's role can be left out of the electronic view 18 by view generation system 46.

To provide this functionality, the present invention can access a set of roles (e.g., for users 16), as well as a set or rules that associate pieces or subsets of migration data with roles. These items can be stored in storage system 30 along with the actual data, or they can be accessed from another location. In either event, the roles could be stored as a hierarchical tree of nodes (e.g., each node is a role) or the like. In such a case, each node of the tree could be associated with one or more rules that indicate what pieces of data are applicable to that role/node.

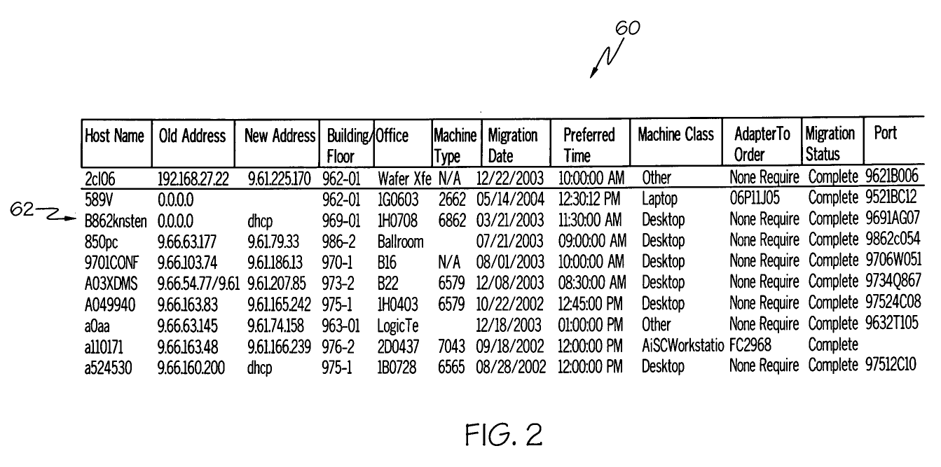

Regardless, once an appropriate electronic view 18 has been generated for a requesting user 16, view display system 48 will display the same for the user 16. Referring to FIG. 2, a first illustrative electronic view 60 according to the present invention is shown. As shown, electronic view 60 contains various records 62 (shown as rows). Each record 62 typically pertains to a particular device (e.g., computerized device) undergoing the IT migration. As can be seen, electronic view 60 sets forth various pieces of data for each device. For example, electronic view 60 sets forth host information, address information, location information, migration information, type information, schedule information, component information, status information and configuration information (e.g., port information) for a device undergoing the IT migration.

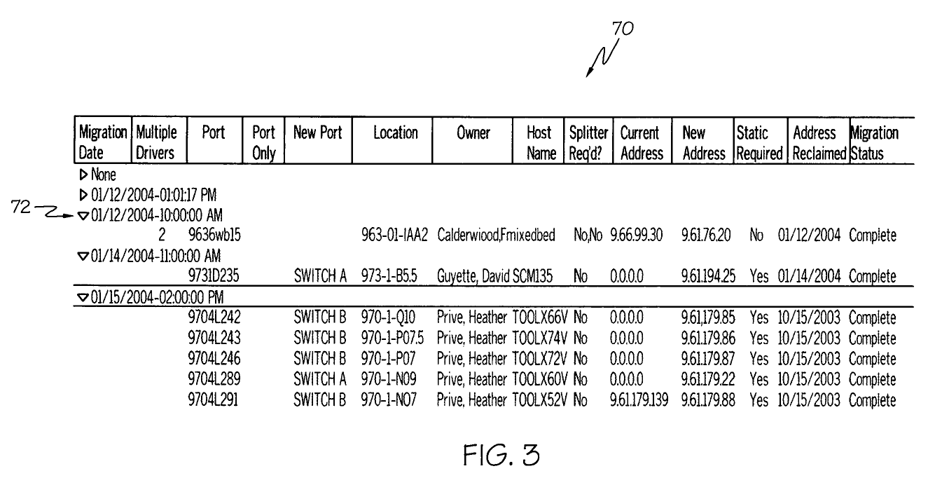

Referring to FIG. 3, another illustrative electronic view 70 according to the present invention is shown. Electronic view 70 is arranged by date as well as by device. Specifically, each record/row 72 of electronic view 70 pertains to a date that represents a migration date. Each date can have one or more devices that are being migrated. To this extent, each date can have an expandable/collapsible menu of devices (as shown). Further, electronic view 70 sets forth date information, driver information, port information, location information, owner information, host information, splitter information, address information, and status information.

Referring back to FIG. 1, data modification system 50 allows a user 16 to modify the data contained in an electronic view 18. Specifically, assume that a user 16 is responsible for physically relocating a piece of computer hardware, and was presented with electronic view 60 of FIG. 2. Further assume that based on feedback from the owner of a device being relocated, user 16 needs to change the migration date. In such a case, data modification system 50 can allow user 16 to edit the migration date directly in the electronic view 60. To this extent, data modification system 50 could prompt the user for a password, or confirmation of the change. Moreover, before the date is actually changed in storage system 30, approval from another individual could be required.

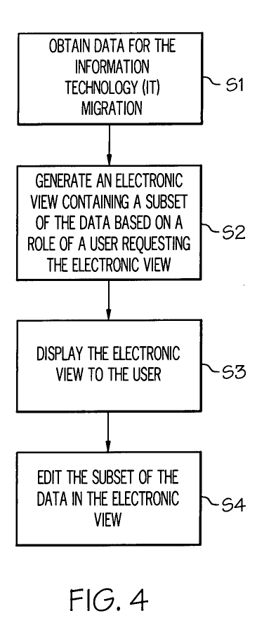

Referring now to FIG. 4, a method flow diagram 100 according to the present invention is shown. First step S1 is to obtain data for the IT migration from a database. Second step S2 is to generate an electronic view containing a subset of the data based on a role of a user requesting the electronic view. Third step S3 is to display the electronic view to the user. Fourth step S4 is to edit the subset of the data in the electronic view.

While shown and described herein as a method and system for managing data for an IT migration, it is understood that the invention further provides various alternative embodiments. For example, in one embodiment, the invention provides a computer-readable/useable medium that includes computer program code to enable a computer infrastructure to manage data for an IT migration. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to manage data for an IT migration. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for managing data for an IT migration. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for managing data for an Information Technology (IT) migration, comprising:
obtaining the data for the IT migration from a database; and
generating an electronic view containing a subset of the data based on a role of a user requesting the electronic view.

2. The computer-implemented method of claim 1, wherein the data comprises host information, address information, location information, migration information, type information, schedule information, component information, status information, and configuration information for a device undergoing the IT migration.

3. The computer-implemented method of claim 1, wherein the electronic view contains a set of records, and wherein each of the set of records corresponds to a different device undergoing the IT migration.

4. The computer-implemented method of claim 1, further comprising receiving edits of the subset of the data in the electronic view.

5. The computer-implemented method of claim 1, further comprising storing the data in the database, wherein the data is stored by a plurality of users.

6. The computer-implemented method of claim 1, further comprising displaying the electronic view for the user, wherein the user is participating in the IT migration.

7. A system for managing data for an Information Technology (IT) migration, comprising:
a system for obtaining the data for the IT migration from a database;
a system for generating an electronic view containing a subset of the data based on a role of a user requesting the electronic view;
a system for displaying the electronic view to the user; and
a system for editing the subset of the data in the electronic view.

8. The system of claim 7, wherein the data comprises host information, address information, location information, migration information, type information, schedule information, component information, status information, and configuration information for a device undergoing the IT migration.

9. The system of claim 7, wherein the electronic view contains a set of records, and wherein each of the set of records corresponds to a different device undergoing the IT migration.

10. The system of claim 7, further comprising a system for storing the data in the database.

11. The system of claim 7, wherein the system for generating comprises a system for selecting the electronic view from a plurality of possible electronic views based on the role of the user.

12. A program product stored on a computer useable medium for managing data for an Information Technology (IT) migration, the computer useable medium comprising program code for causing a computer system to perform the following steps:
obtaining the data for the IT migration from a database;
generating an electronic view containing a subset of the data based on a role of a user requesting the electronic view;
displaying the electronic view to the user; and
editing the subset of the data in the electronic view.

13. The program product of claim 12, wherein the data comprises host information, address information, location information, migration information, type information, schedule information, component information, status information, and configuration information for a device undergoing the IT migration.

14. The program product of claim 12, wherein the electronic view contains a set of records, and wherein each of the set of records corresponds to a different device undergoing the IT migration.

15. The program product of claim 12, wherein the program code further causes a computer system to perform the following step: storing the data in the database.

16. The program product of claim 12, wherein the electronic view is selected from a plurality of possible electronic views based on the role of the user.

17. A method for deploying an application for managing data for an Information Technology (IT) migration, comprising:
providing a computer infrastructure being operable to:
obtain the data for the IT migration from a database;
generate an electronic view containing a subset of the data based on a role of a user requesting the electronic view;
display the electronic view to the user; and
edit the subset of the data in the electronic view.

18. The method of claim 17, wherein the data comprises host information, address information, location information, migration information, type information, schedule information, component information, status information, and configuration information for a device undergoing the IT migration.

19. The method of claim 17, wherein the electronic view contains a set of records, and wherein each of the set of records corresponds to a different device undergoing the IT migration.

20. The method of claim 17, wherein the computer infrastructure is further operable to store the data in the database.
